(19) United States
(12) Patent Application Publication
(10) Pub. No.: US 2007/0245353 A1
(43) Pub. Date: Oct. 18, 2007

(54) Secure integration of a local and a remote application

(76) Inventor: Amir Ben-Dor, Bellevue, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/375,478

(22) Filed: Mar. 14, 2006

(51) Int. Cl. G06F 9/46

(52) U.S. Cl. 719/318

(57) ABSTRACT

One embodiment of the present invention is a method for integrating a local application-program-generated graphical visualization with a remotely generated web page displayed locally by a web browser. In this embodiment, the locally executing web browser is modified to invoke an event-handling routine upon rendering each web page. When target web pages are rendered by the web browser, the event-handling routine interfaces with a locally executing application to generate a graphical visualization that corresponds to information displayed on the target web page and inserts the locally generated graphical visualization into the web page for integrated display, by the web browser, of both locally generated graphical visualization and remotely generated information displayed on the web page. In additional embodiments of the present invention, information produced by any of various different computational entities resident on a local computer system is synchronized with, and integrated with, remotely generated information rendered by a web browser on the local system by modifying the web browser to invoke an event handler upon rendering remotely generated information as, or as part of, a displayed web page.

### TECHNICAL FIELD

The present invention is related to integration of application programs, data bases, and other computational entities and, in particular, to a method and system for integrating two or more computational entities to provide an integrated, computational entity with more features, greater capabilities, or larger scope than provided by individual computational entities.

### BACKGROUND OF THE INVENTION

As computer systems have become more accessible and economical, the number of different types of application programs, databases, and other useful computational entities has greatly increased, and continues to increase with each passing year. With the introduction and wide acceptance of increasingly high-bandwidth interconnections between computers, including the Internet, computer users have access not only to an ever-increasing number of increasingly powerful and useful applications, databases, and other computational entities that execute on a user's local computer, but also access through the Internet and other communications means to an enormous number of applications, data bases, and other computational entities that execute on a wide variety of remote computer systems. Frequently, a user may wish to take advantage of features and capabilities of a number of different application programs, databases, or other computational entities that are not all provided by a single computational entity. In such cases, it may be desirable to the user to find a single application program, database, or other computational entity that provides the full set of features and capabilities desired by the user, but often no such fully featured and fully capable computational entity exists. In such cases, the user may choose to use two or more different application programs, databases, or other computational entities concurrently, or may seek an integrated, single computational entity by developing the computational entity, contracting for development of the computational entity, or by another means. Unfortunately, both approaches may be problematic. Concurrent use of two or more different computational entities may involve constant, tedious manipulation of one or more of the entities in order to achieve an integrated result. Moreover, it may be difficult or impossible to concurrently use two or more computational entities in a fashion that produces a satisfactory, combined result. On the other hand, developing an integrated solution that combines the features and capabilities of two or more discrete computational entities may be time consuming and expensive. In the case that a user needs to integrate a local computational entity with a remote computational entity, security problems, local-computational-resource problems, and coordination problems may be difficult or impossible to overcome. For these reasons, users of, developers of, and vendors of various application programs, databases, and other computational entities continue to seek efficient methods for integrating two or more discrete computational entities to provide a single, integrated computational entity with a greater number of features, greater capabilities, or a larger scope than provided by any single, existing computational entity.

### SUMMARY OF THE INVENTION

One embodiment of the present invention is a method for integrating a local application-program-generated graphical visualization with a remotely generated web page displayed locally by a web browser. In this embodiment, the locally executing web browser is modified to invoke an event-handling routine upon rendering each web page. When target web pages are rendered by the web browser, the event-handling routine interfaces with a locally executing application to generate a graphical visualization that corresponds to information displayed on the target web page and inserts the locally generated graphical visualization into the web page for integrated display, by the web browser, of both locally generated graphical visualization and remotely generated information displayed on the web page.

In additional embodiments of the present invention, information produced by any of various different computational entities resident on a local computer system is synchronized with, and integrated with, remotely generated information rendered by a web browser on the local system by modifying the web browser to invoke an event handler upon rendering remotely generated information as, or as part of, a displayed web page. The event handler determines, from a representation of the displayed web page, information to be obtained from the local information-generating computational entity, obtains the information from the local information-generating web entity, configures the information, if necessary, for coordinated rendering with the remotely generated information, and then inserts the locally generated information into a representation of the web page so that the locally generated information is displayed, or rendered, along with remotely generated information in a coordinated and integrated fashion.

### BRIEF DESCRIPTION OF THE DRAWINGS

FIG. 1 shows a graphical visualization of DNA-copy data displayed on a computer screen by an application program local to a user's computer.

FIG. 2 shows a portion of a web page that may be downloaded and displayed by a local browser from a remote genomic-information server.

FIGS. 3A-C illustrate a computational environment in which graphical visualizations shown in FIG. 1 and 2 are generated and displayed.

FIGS. 4A-B illustrate two different techniques that might be used to coordinate and integrate display of the graphical visualizations discussed with reference to FIGS. 1 and 2.

FIGS. 5A-C illustrate different possible methods for integrating visual display of the locally generated genomic data and the remotely generated genomic data within a single-user interface, including an embodiment of the present invention.

FIG. 6 shows the integrated display of locally generated DNA-copy-number data and genomic data retrieved from a remote genomic-data facility within a single-user interface according to one embodiment of the present invention.

FIGS. 7A-B show the first portion of a genomic-data-displaying web page generated by the UCSC genomic-data facility.

FIGS. 8A-C show a portion of the HTML encoding of the web page shown in FIGS. 7A-B.

FIG. 9 shows the top portion of the DOM data structure for the genomic-data-displaying web page shown in FIGS. 7A-B and encoded in the HTML file shown in FIGS. 8A-C.

FIGS. 10-12 show control-flow diagrams that represent a method embodiment of the present invention.

### DETAILED DESCRIPTION OF THE INVENTION

Embodiments of the present invention are directed to coordination and integration of two or more different computational entities, such as application programs, database management systems, or other information-producing or information-rendering computational entities, in order to produce an integrated computational entity with a number of features, capabilities, or scope greater than the number of features, capabilities, and scope of any of the individual computational entities that are together coordinated and integrated. In the following discussion, locally stored, processed, and graphically rendered genomic information is integrated with remotely stored and processed information for integrated display on a local computer system. This example, used for describing the present invention in the following discussion, is but one example of a multitude of different types of computational entities that can be coordinated and integrated by means of method embodiments of the present invention. The coordinated and integrated display of both local and remote genomic information described in the following discussion represents but one of many possible integrated systems for processing and rendering information obtained from two or more different computational entities.

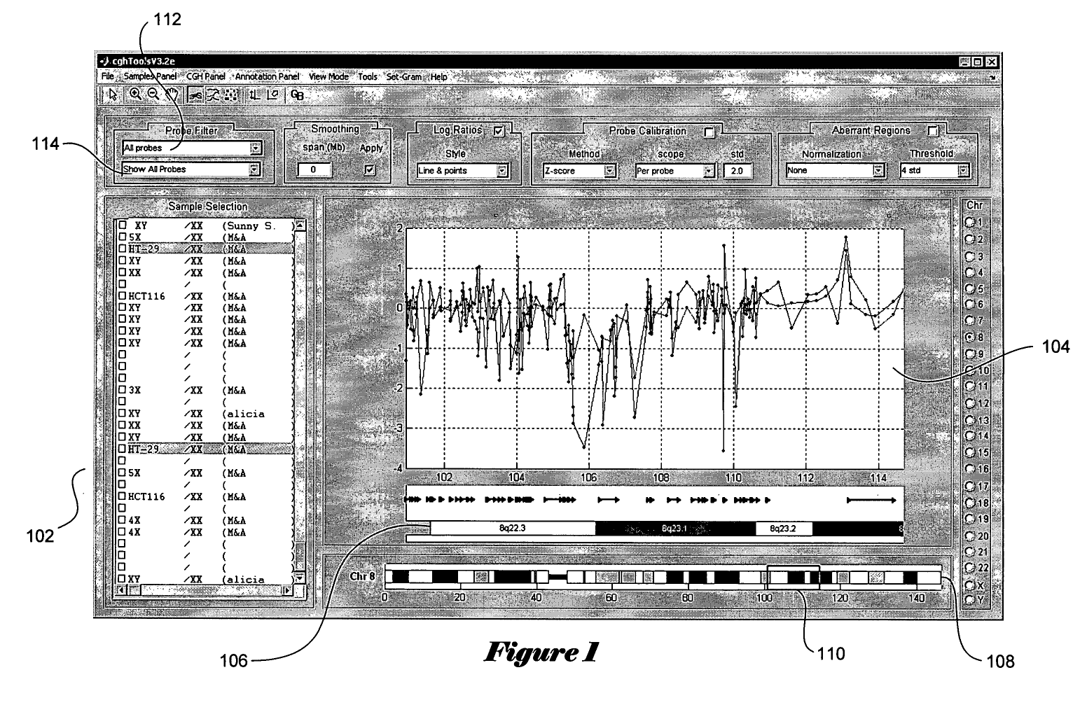

FIG. 1 shows a graphical visualization of DNA-copy data displayed on a computer screen by an application program local to a user's computer. The graphical visualization consists primarily of a plot of experimentally determined DNA copy numbers for probes 104 along a short region of a chromosome. The short region is abstractly represented as a horizontal bar 106 partitioned into DNA subsequences, each subsequence numerically labeled and differentially shaded for rapid, visual identification of subsequences corresponding to the plotted DNA-copy data in the graphical representation 104. A larger-scale abstract representation of the chromosome 108 is provided below the graphical representation and 104 in subsequence graphic 106, with the subsequence for which DNA-copy data is displayed indicated by a box-like graphic 110 enclosing the sequence within the larger-scale presentation of the chromosome 108. The graphical visualization 102 also contains numerous input features, such as input features 112 and 114, which allow a user to select and modify display of genomic information related to a desired chromosomal region.

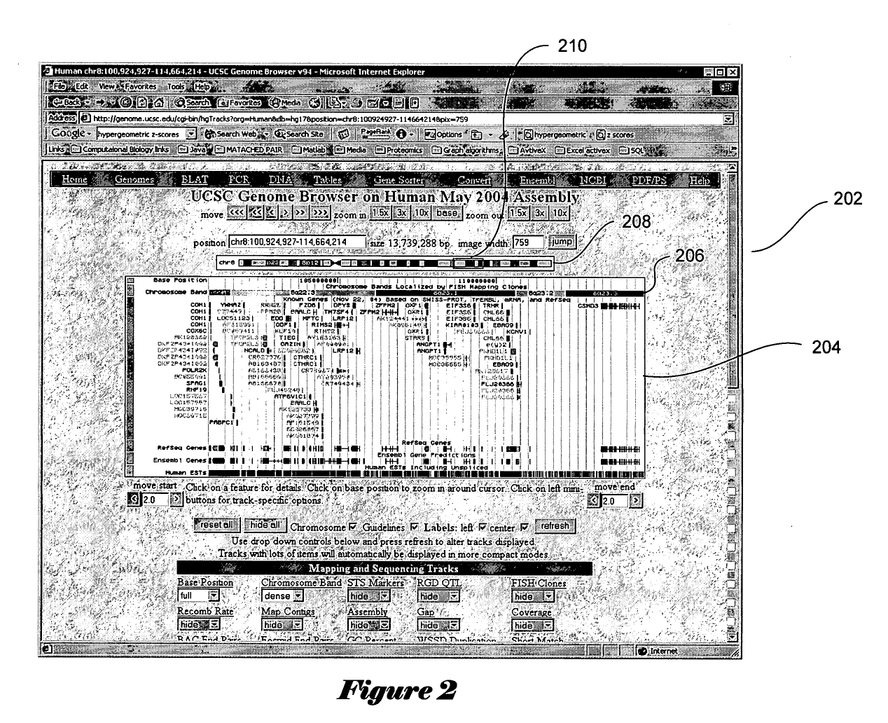

FIG. 2 shows a portion of a web page that may be downloaded and displayed by a local browser from a remote genomic-information server. In the example shown in FIG. 2, the web page 202 is downloaded from the University of California at Santa Clara (“UCSC”) genomic-data web site “http://genome.uscs.edu/.” The web page allows a user to select for display of an enormous amount of information concerning a selected chromosomal region. The information is displayed in a graphic visualization 204 that, in the example shown in FIG. 2, includes a representation of the chromosomal subsequence 206 similar to the horizontal-bar representation (106 in FIG. 1) displayed in the locally generated graphic visualization, discussed above. A larger-scale representation of the chromosome 208 is also displayed, with a box-like graphic 210 indicating the subsequence of the chromosome that is displayed in greater detail in the graphical visualization 204. The web page 202 is displaying annotations and other information from the same genomic subsequence for which DNA-copy information is displayed in the graphical visualization shown in FIG. 1.

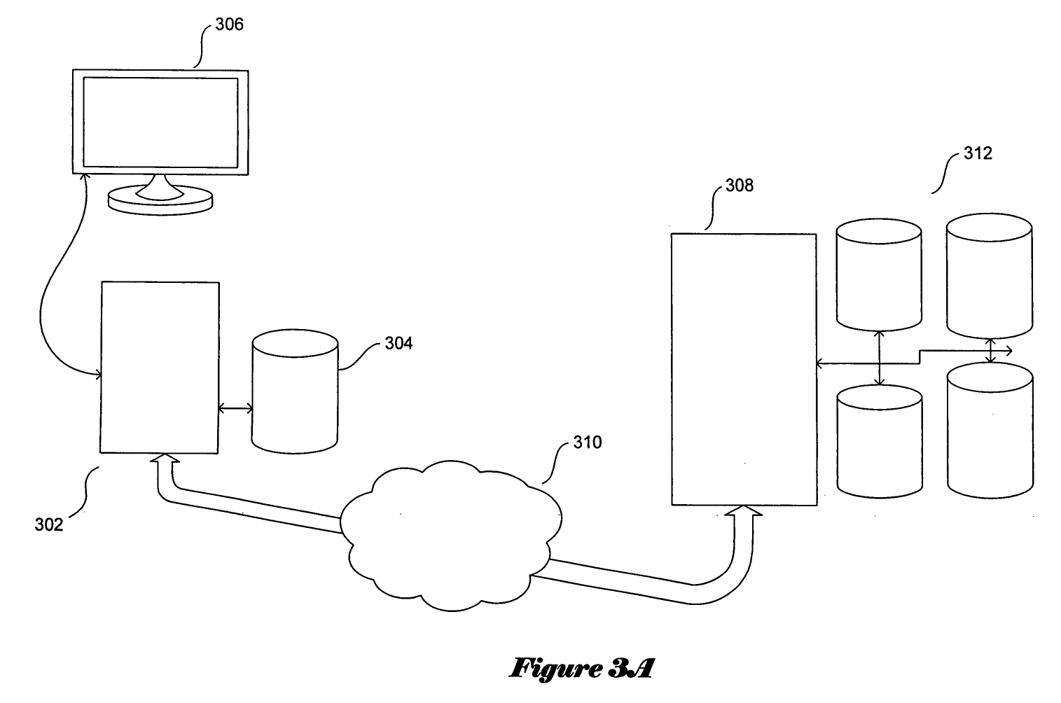

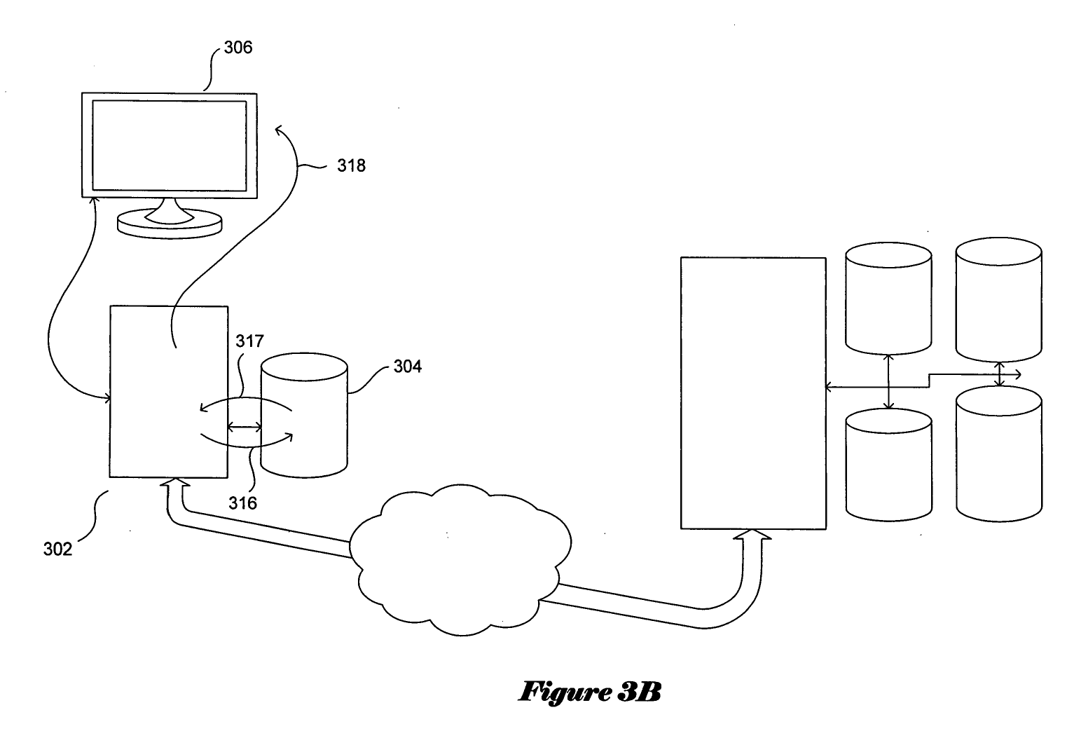

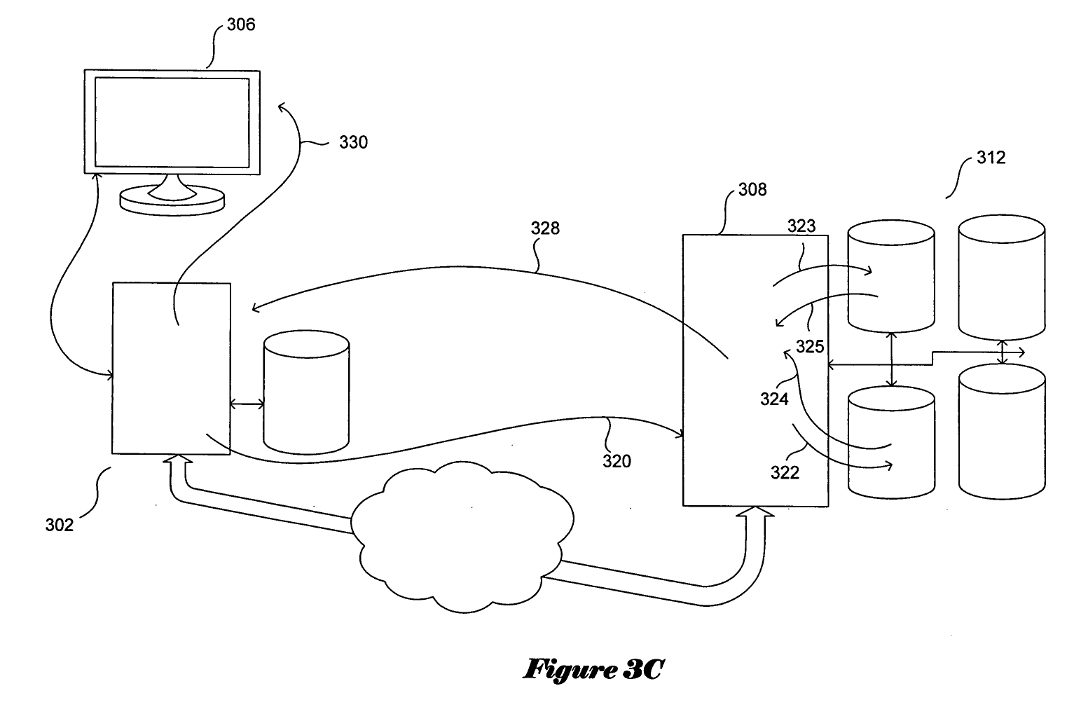

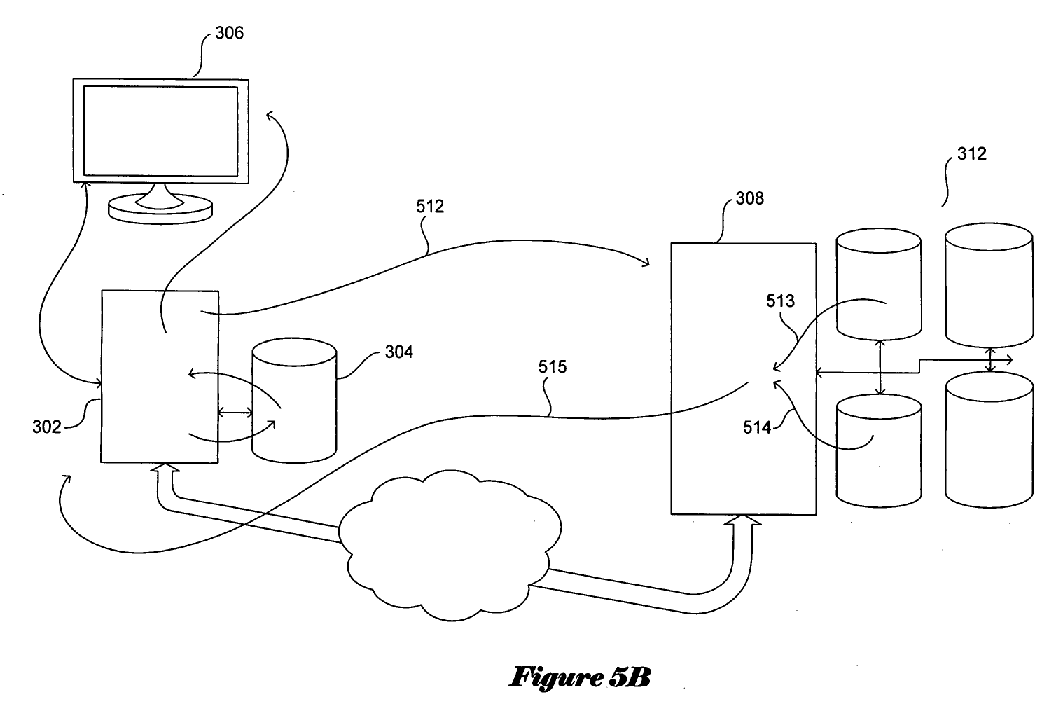

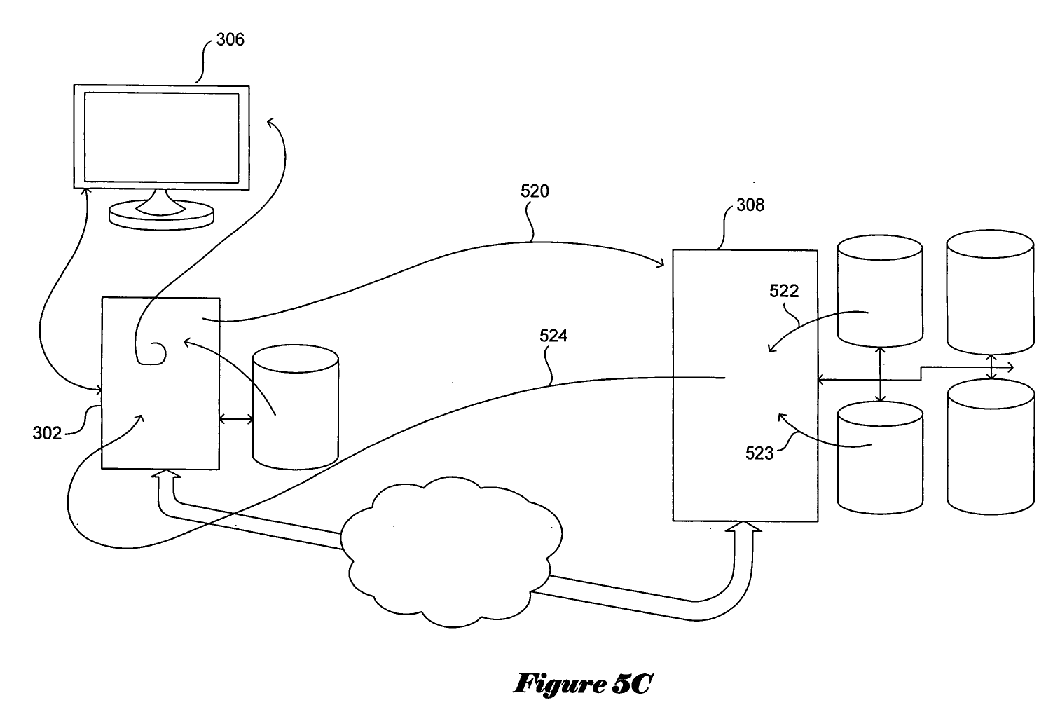

FIGS. 3A-C illustrate a computational environment in which graphical visualizations shown in FIG. 1 and 2 are generated and displayed. The environment is identically illustrated in FIGS. 3A-C and in FIGS. 5A-C, discussed below. As shown in FIG. 3A, the system includes a local, user computer 302 with local data storage 304 and a local display device 306. The local, user computer system 302 is interconnected with a remote genomic-data server 308 via the Internet 310. The remote, genomic-data server 308 is interconnected with a large, remote data-storage facility 312.

FIG. 3B illustrates generation and rendering of the graphical visualization discussed above with reference to FIG. 1. DNA-copy-number data is stored on the local storage device 304 and accessed 306-307 by an application program running within the local computer system 302. The application program processes the accessed DNA-copy-number data to produce an electronic representation of the graphical visualization (102 in FIG. 1) that it then transmits 308 to the local display device 306 for display to a user.

FIG. 3C illustrates the process by which the graphical visualization discussed with respect to FIG. 2 is generated and displayed in the computational environment discussed above with reference to FIG. 3A. As shown in FIG. 3C, an Internet-browser application executing within the local computer system 302 requests 320 the web page for display from the remote genomic-data server 308. An application program running on the remote, genomic-data server 308 accesses 322-325 genomic data from the data-storage facility 312 and compiles that data, along with other information, into an electric representation of the web page and transmits 328 the electronic representation of the web page back to the local computer system 302. The Internet-browser application running within the local computer system 302 then renders the electronic representation of the web page for display, and transmits the rendering 330 to the local display device 306 for display to a user. In the genomic-data example presently discussed, the web page is electronically encoded as a HyperText Markup Language (“HTML”) file.

As can be seen in the graphical visualizations shown in FIGS. 1 and 2, the two different graphical visualizations display markedly different information concerning the selected chromosome subsequence. The locally generated graphical visualization shown in FIG. 1 displays DNA-copy-number data that may, for example, have been generated in the user's research laboratory and stored within the user's computer system for subsequent analysis that may lead, eventually, to development of proprietary diagnostic techniques or therapies for treating pathological conditions associated with DNA-copy-number abnormalities. By contrast, the web page shown in FIG. 2 displays a vast amount of publicly available, compiled information about the selected chromosome subsequence, including detailed information about any genes included within the segment, experimental results culled from a large number of geographically dispersed research laboratories, and much additional information. When analyzing the DNA-copy-number data, the user may well desire to display the graphical visualization of the DNA-copy-number data along with, scaled to, and aligned with, the large amount of publicly available information for the selected chromosomal sequence displayed in the web page. Such concurrent, scaled, and aligned display of the locally generated DNA-copy-number-data visualization with the web page information allows the user to quickly identify particular genes associated with abnormal DNA-copy-numbers and to quickly retrieve a wide variety of additional information and research results concerning the gene or genes.

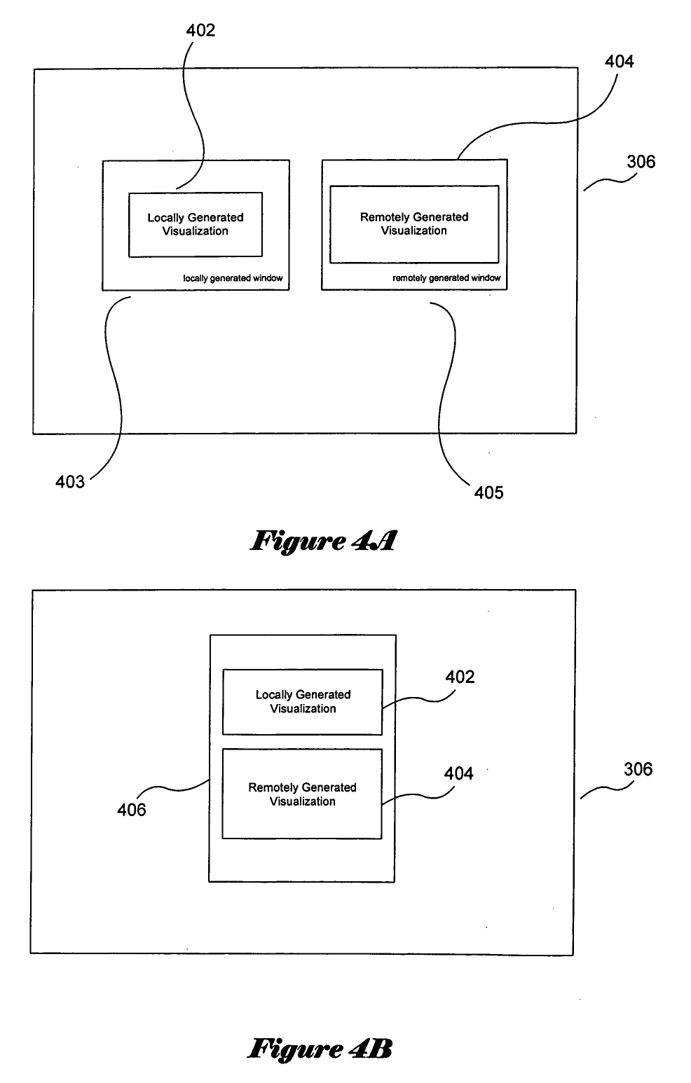

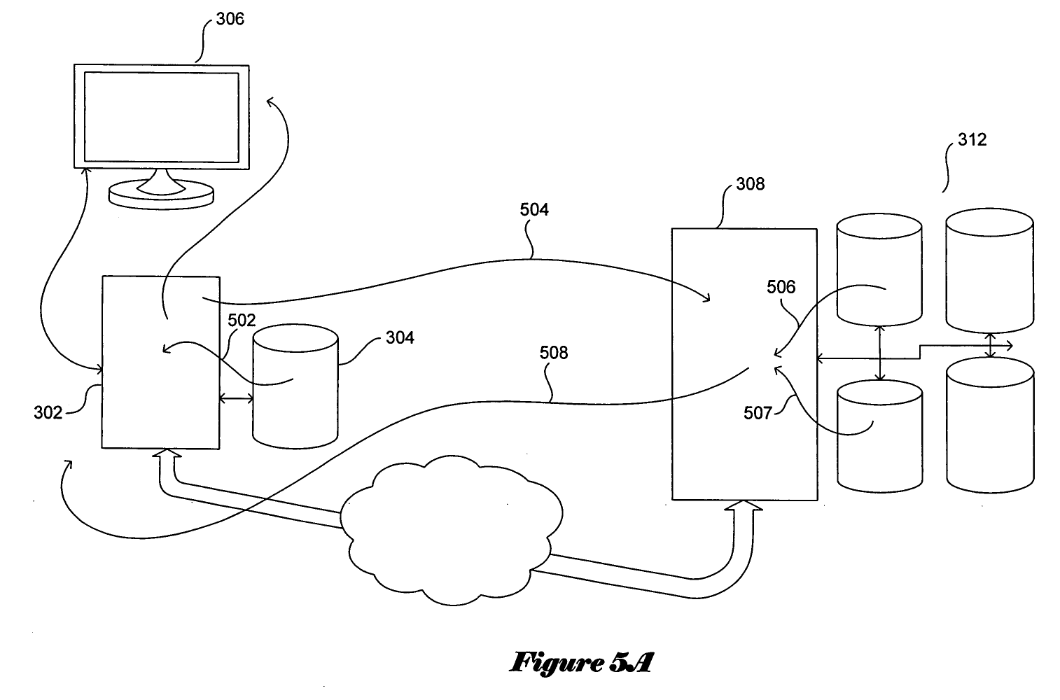

FIGS. 4A-B illustrate two different techniques that might be used to coordinate and integrate display of the graphical visualizations discussed with reference to FIGS. 1 and 2. In FIG. 4A, the locally generated DNA-copy-number graphical visualization 402, or user interface (“UI”), is displayed in a first window 403 on the local display device 306, while the remotely generated web page 404, also a UI, is displayed in the second window 405 on the local display device 306. Display of the graphical visualizations in two different windows, horizontally or vertically aligned, would provide for simultaneous display of both the DNA-copy-number data as well as the genomic data accessed from the remote genomic-data server. However, to obtain coordinated display of locally generated genomic data and remotely generated genomic data, the user would need to separately input data and commands into input features of the two concurrently displayed graphical visualizations in order to coordinate concurrent display of a selected chromosomal subsequence. Because the data input and commands may differ between the two different user interfaces, the user would need to remember two different command sets as well as separately manipulate the two different user interfaces. Moreover, whether horizontally or vertically aligned, the display of the two different data sets in two different windows necessarily results in the graphical representations of the two different data sets being separated from one another by various borders, frames, and display features, so that the two different graphical representations of the data cannot be easily scanned and visually compared. Alternatively, as shown in FIG. 4B, the locally generated graphical visualization of the DNA-copy-number data 402 and the remotely generated genomic-data web page 404 may be displayed together within a single-user interface displayed within a single window 406 on the local display device 306. The integrated display of the locally generated graphical visualization and remotely generated web page within a single window alleviates the visual scanning and alignment problems that may arise when the graphical visualizations are separately displayed in two different windows, as discussed above with reference to FIG. 4A. Moreover, when properly developed, the single-user interface in which both the locally generated graphical visualization and the remotely generated web page are displayed may provide a single set of input features and commands to allow the user to select a desired chromosomal subsequence and simultaneously display DNA-copy-number data and general, publicly available genome data for the desired chromosomal subsequence, addressing the two-command-set, two-different-UI-manipulation problems discussed above with reference to FIG. 4A.

FIGS. 5A-C illustrate different possible methods for integrating visual display of the locally generated genomic data and the remotely generated genomic data within a single-user interface, including an embodiment of the present invention. FIGS. 5A-B represent general, currently available methods, and FIG. 5C illustrates a method embodiment of the present invention. FIG. 5A illustrates a first method that involves generating the single-user interface on the remote genomic-data server. This method involves accessing 502 the local data from the local data-storage device 304, processing the local data by a local application running on the local computer system 302, and transferring an electronically encoded representation of the processed data 504 to the remote genomic-data server 308. An application program running on the remote genomic-data server then determines the chromosomal subsequence in the transmitted encoding and accesses 506-507 related genomic information in the data-storage facility 312 that is then rendered and combined with the encoded information transferred from the local computer to generate an electronic encoding of a single, integrated visualization of both the transmitted data and the genomic data retrieved from the data-storage facility 312. The electronic encoding is transmitted 508 back to the Internet-browser application running on a local computer 302 for rendering and display on the local display device 306.

There are a number of problems with the approach to integrated display illustrated in FIG. 5A. First, the locally generated genomic data must be encoded in a form that can be recognized and processed by the remote genomic-data server. This may involve either a great deal of development effort directed to specific users on the part of the genomic-data facility that manages the genomic-data server, or development of one or more standards for encoding and transmitting local genomic data. In the latter case, the standards may provide only a limited capability for encoding a wide variety of different types of genomic data that may be generated and stored by various different users. Thus, users could take advantage of only those common display techniques and encodings for which the application program running on the remote genomic-data server has been designed to provide. Probably an even more serious problem, for many users, is that the locally generated data needs to be transmitted in a computer-readable form to a remote computer system, potentially exposing the local data to access by remote users, spyware, malicious individuals and organizations that may tap into and monitor Internet communications, and various other individuals and organizations outside of, and uncontrolled by, the local user and the local user's organization. Such security issues are especially important for scientific and medical researchers who intend to user the results of data analysis for developing and marketing new diagnostic tools, therapeutics, and other useful products and services. Because of these problems, the first method illustrated in FIG. 5A is generally impractical and undesirable for many users.

FIG. 5B illustrates a second method for generating and displaying both local graphical visualizations and remote graphical visualizations within a single-user interface displayed on a local computer. In the second method, the user computer accesses 512-515 relevant portions of the genomic data stored on the remote data-storage facility 312 via the remote genomic-data server 308. This relevant genomic data is then stored in the storage device 304 of the local computer system along with any locally generated and stored genomic data. The locally stored genomic data can then be accessed along with the locally generated and locally stored genomic data by an application running on the local computer system 302 to generate simultaneously displayed graphical visualizations of both locally generated and remotely generated data sets within a single-user interface that is encoded and transmitted to the local display device 306 for display to a user.

This second method for integrated display illustrated in FIG. 5B is also associated with a number of problems. First, an enormous amount of data may need to be transferred from the remote data-storage facility 312 to the local computer system. The local computer system may not generally have sufficient data-storage and data-manipulation resources to store, access, and process this enormous amount of data. Furthermore, the data stored on the remote data-storage facility 312 may be stored in one or more formats that require special programming of the local computer system for access, storage, and processing. The development effort required to import and use the remote genomic data may be significantly expensive in time and resources to make the method illustrated in FIG. 5B practically and commercially unfeasible. Furthermore, while the data stored by the remote genomic-data facility may be publicly available, many of the tools for manipulating that data and generating graphical visualizations, such as the web page shown in FIG. 2, may be proprietary to the remote genomic-data facility, frustrating the ability of a local user to duplicate the desired graphical visualization of the remotely stored, publicly available genomic data. Finally, were a copy of the remote data to be downloaded to the local computer system, the data would need to maintained and constantly updated, since the remote data-storage facility manages a dynamic, constantly changing database that tracks research and contributions from around the world. The maintenance and updating of the data would be an enormously expensive and time consuming task. For all of these reasons, the second method illustrated in FIG. 5B is generally impractical or commercially unfeasible.

FIG. 5C illustrates one method embodiment of the present invention. This method embodiment of the present invention allows for both the locally generated genomic data and the remotely stored genomic data to be separately rendered for graphical presentation to a user, but presented to the user in a single-user interface with a single-input feature and command set. In this method, a modified Internet-browser application runs on the local computer system 302. The user manipulates the web-page user interface provided by the remote genomic-data facility to select a desired chromosomal subsequence. The web page that includes genomic information related to the selected chromosomal subsequence is requested 520 by the local, modified Internet-browser application from the remote genomic-data server 308, which collects 522-523 and assembles the requested data into a web page that is electronically encoded in an HTML file and returned 524 to the modified Internet-browser application just as in the process described with reference to FIG. 3C. In other words, the method embodiment of the present invention illustrated in FIG. 5C does not rely on modifications to the application program running on the remote genomic-data server 308. The modified Internet-browser application running on the local computer 302 automatically calls an external event-handler routine stored on the local computer upon downloading the HTML-encoded web page transmitted to the local computer system by the remote genomic-data server 308. The external event-handler routine then determines the identity of the chromosomal subsequence for which data is included in the web page, and directs a local application program running on the local computer system to retrieve and process locally generated and locally stored genomic data, such as the DNA-copy-number data described above, scales the generated graphical visualization of the locally generated and locally stored data to be compatible with the remotely generated web page, and inserts a reference to the encoded, graphical representation of the locally stored and locally generated genomic data into the HTML representation of the web page. The modified web page that includes both the graphical visualization of the locally stored and locally generated genomic data, as well as a graphical visualization of the remote genomic data is then transmitted to the local display device 306 for display to the user. It should be noted that the method of FIG. 5C allows a user to continuously, interactively employ input, navigational, and other features provided by the application program running on the remote genomic-data server to access and display information, with the local data automatically aligned and displayed to maintain both the data received from the remote genomic-data server and the local data in a desired correspondence.

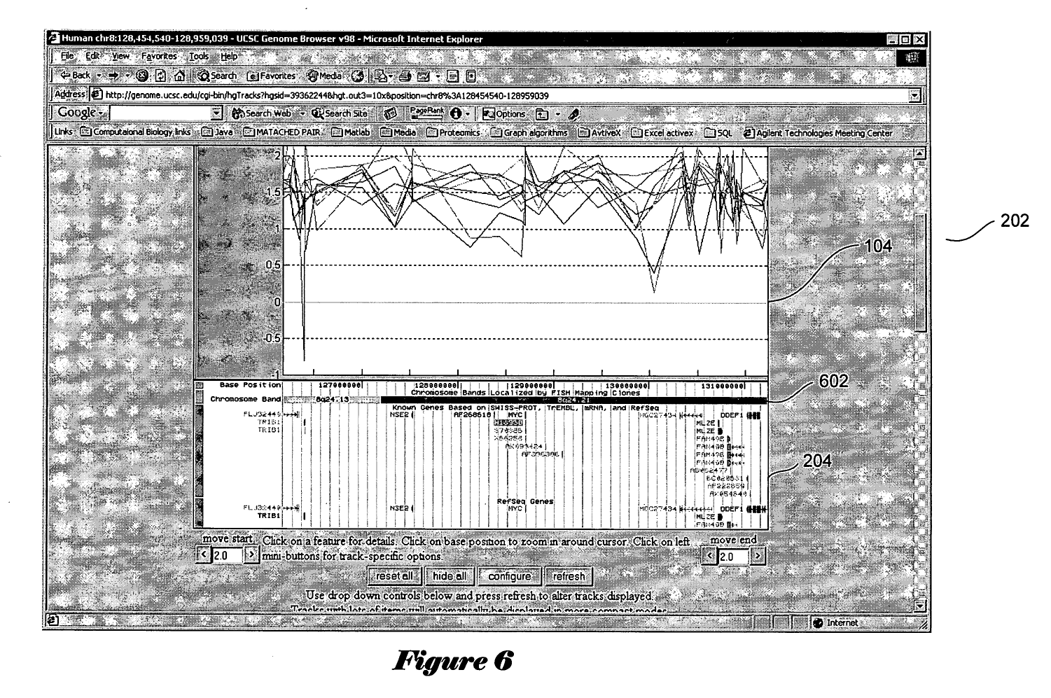

FIG. 6 shows the integrated display of locally generated DNA-copy-number data and genomic data retrieved from a remote genomic-data facility within a single UI according to one embodiment of the present invention. As can be seen in FIG. 1, the locally generated graphical visualization 104 has been inserted into the web page 202 constructed on the remote genomic-data server for integrated display to a user on the local computer system. The graphical visualization of the locally generated DNA-copy-data number 104 has been scaled and aligned with the graphical visualization 204 of the genomic data for a common chromosomal subsequence represented by the horizontal chromosome band 602 displayed in the graphical visualization 204 of the genomic data.

The method embodiment of the present invention discussed with reference to FIG. 5C represents a solution to the problems attendant with currently available methods for integrating the local and remote genomic data discussed with reference to FIGS. 5A-B. The method embodiment of the present invention does not rely on, or need, changes or alternations to the application program running on the genomic-data server that prepares and transmits genomic-data-displaying web pages. The integrated display, an example of which was shown in FIG. 6, does not rely on, or need, local genomic data to be transmitted to the remote genomic-data server, thus avoiding the serious security problems associated with the first currently available method discussed with reference to FIG. 5A. Moreover, the locally generated genomic data is processed and rendered for display entirely on the local computer system, avoiding any need for encoding, processing, and display standards. Because no changes need be made to the application program running on the remote genomic-data server, and because the local application program need not download or process raw genomic data from the remote genomic-data facility, the problems associated with the second currently available method for integrating display of local and remote genomic data discussed with reference to FIG. 5B are also avoided.

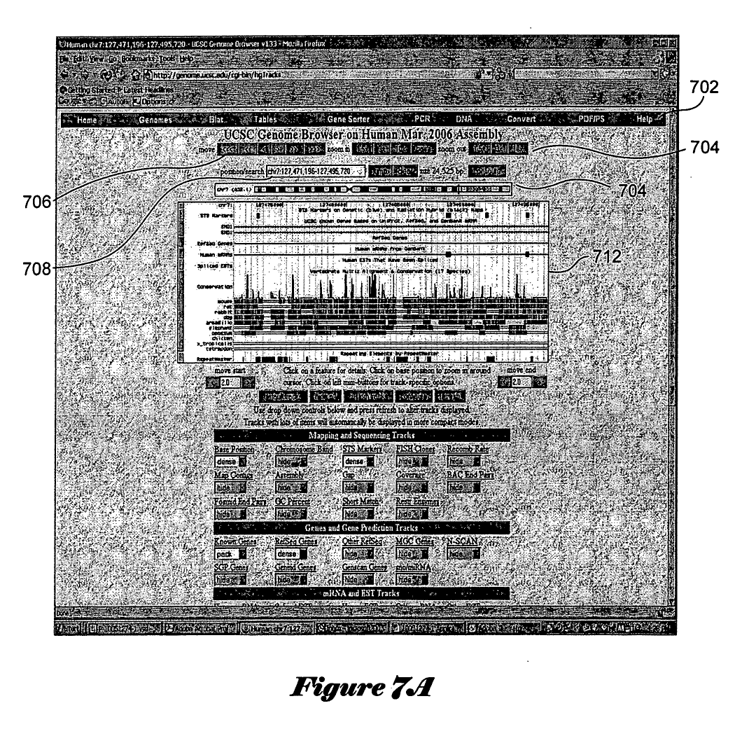

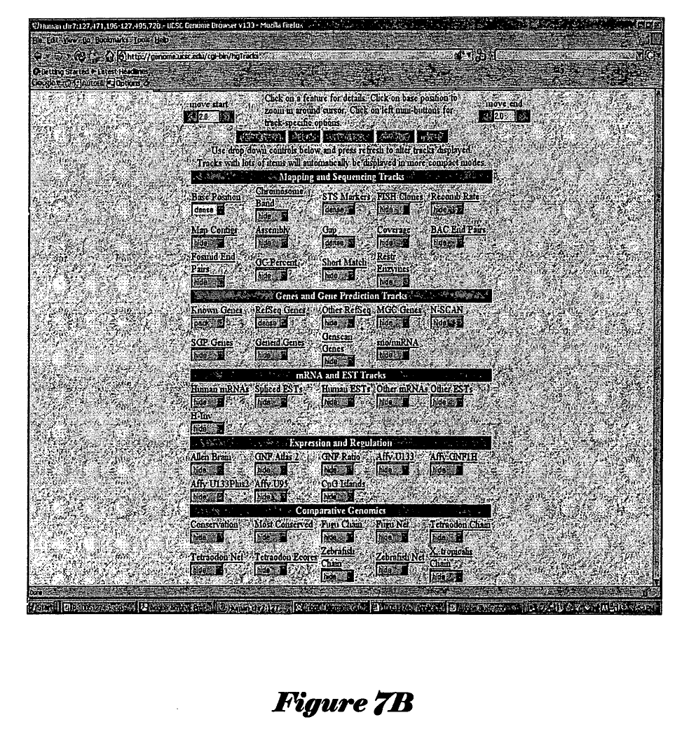

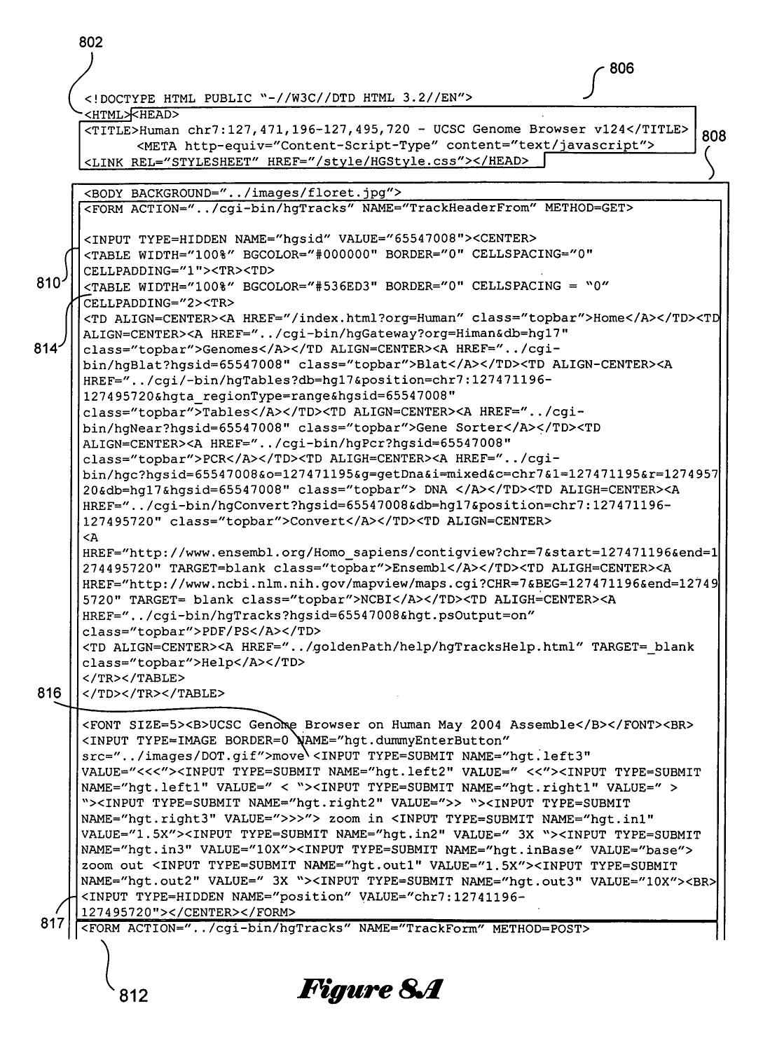

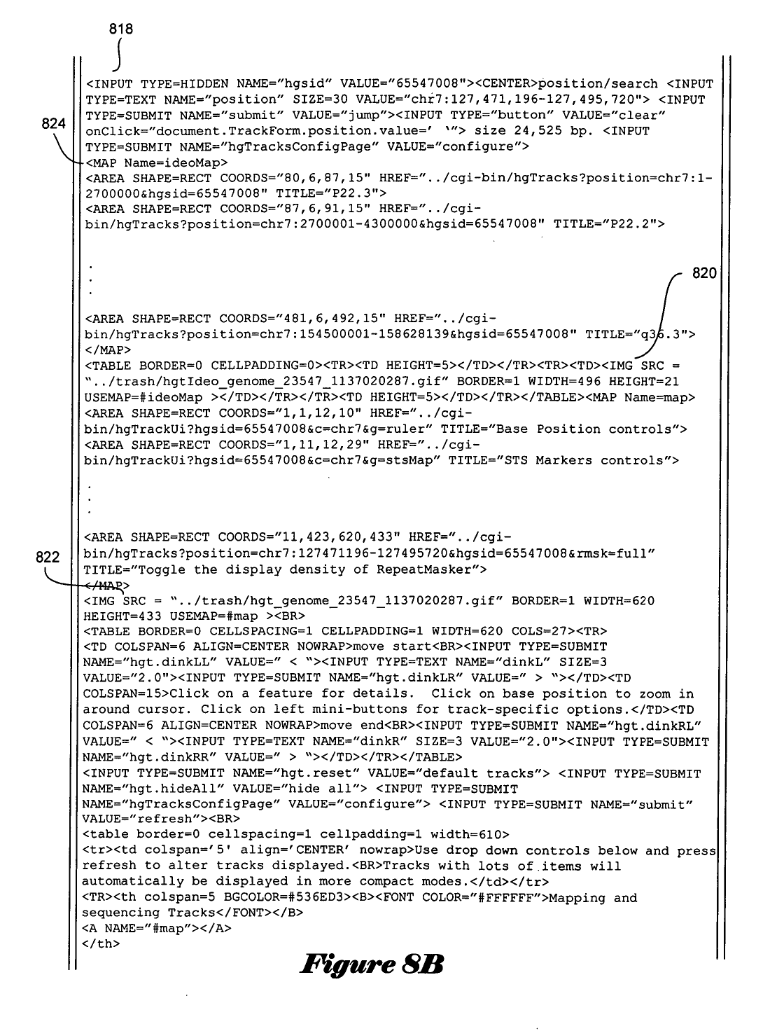

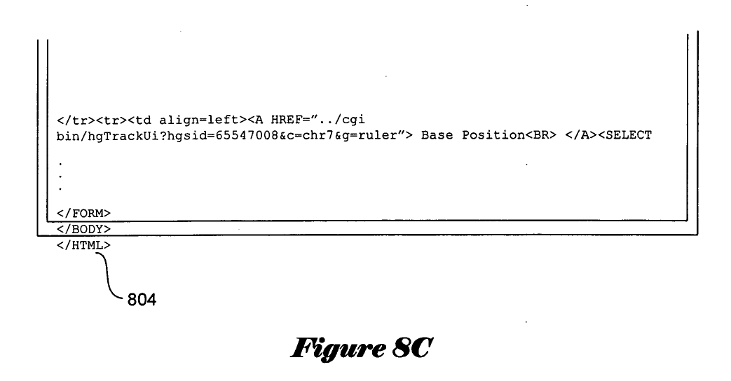

FIGS. 7A-B show the first portion of a genomic-data-displaying web page generated by the UCSC genomic-data facility. FIGS. 8A-C show a portion of the HTML encoding of the web page shown in FIGS. 7A-B. The HTML encoding of the web page is hierarchically structured. Different hierarchical portions of the web page are encoded by various HTML tags. For example, the entire web page is encoded by a root-level <HTML> tag 802 in FIG. 8A and 804 in FIG. 8C. Many tags, such as the <HTML> tag, occur as a pair of tags that bracket the contents of the hierarchical portion of the document represented by the tag, the second tag of the pair including a “\” directly following the left-hand angle bracket “<.” An HTML document has two main hierarchical portions: (1) the HEAD portion 806 introduced by the tag <HEAD>; and (2) the body portion introduced by the tag <BODY> 808. In FIGS. 8A-C, boxes have been drawn around certain of the highest-level portions, including the HEAD portion, the BODY portion, and two FORM portions included in the BODY portion. The BODY portion 808 includes a first FORM portion 810 and a second FORM portion 812. The FORM portions represent portions of the displayed web page that include input features to allow a user to input commands and data to the web page in order to control subsequent display of information on subsequently generated and transmitted web pages. For example, the first FORM 810 includes the top-level bar (702 in FIG. 7A) that allows a user to navigate to various portions of the genomic-data-facility web site, encoded as a TABLE 814 and a first horizontal row of input buttons (704 in FIG. 7A), such as input button 706 encoded as an INPUT portion 816. The second FORM 812 includes the remainder of the web page. For example, the position/search input field 708 is encoded as an INPUT portion 817 within the first FORM 810 and also as an INPUT portion 818 within the second FORM 812. The web page includes two images: (1) a small image representing the chromosome at large scale 710, encoded as a first IMG portion introduced by the tag <IMG . . . > 820; and (2) the graphical visualization of the genomic data 712 encoded as a second IMG portion 822. Various features within the images are mapped to logical input areas by image maps, represented in the HTML by MAP portions, such as MAP portion 824.

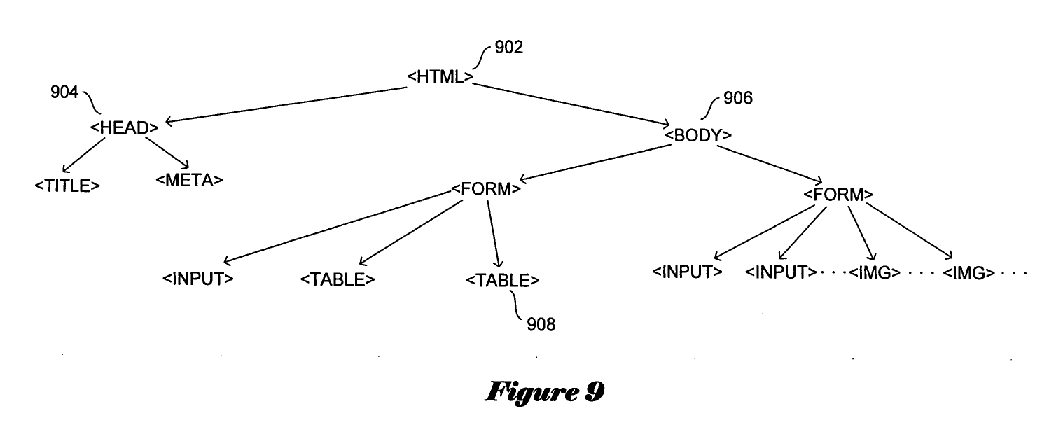

The HTML encoding of the web page constitutes an HTML text file, a portion of which is shown in FIGS. 8A-C, as well as many additional HTML text files, image files, routines, and other such entities referenced from the HTML file. The HTML encoding of the web page is also represented, at rendering and display time, within an Internet-browsing application as a document object model (“DOM”) hierarchical data structure. FIG. 9 shows the top-level portion of the DOM data structure for the genomic-data-displaying web page shown in FIGS. 7A-B and encoded in the HTML file shown in FIGS. 8A-C. Thus, in FIG. 9, the HTML tag 902is at the root of the DOM tree, with the <HEAD> tag 904and the <BODY> tag 906 representing two children of the root-level <HTML> tag. Each of the leaf-level tags shown in FIG. 9, such as <TABLE> tag 908, is actually the root of a generally much larger subtree. The subtrees are not shown in FIG. 9 for simplicity of illustration.

The DOM tree for a web page downloaded by an Internet-browser application is available to event-handler routines that can be registered with the Internet-browser application program by a user in order to customize the Internet-browser application. Internet-browser applications generally provide an application programming interface (“API”) to allow a user to programmatically navigate the DOM tree and to modify the DOM tree, thus modifying a downloaded web page prior to rendering and display of the downloaded web page by the Internet-browser application. This capability is used by method embodiments of the present invention to modify a web page produced by one computational entity in order to include information generated by a second computational entity within the web page to provide an integrated web page that displays both sets of information generated by the two different computational entities. This method can be extended to include information generated by additional computational entities within a single web page, providing an integrated display of information via a single UI.

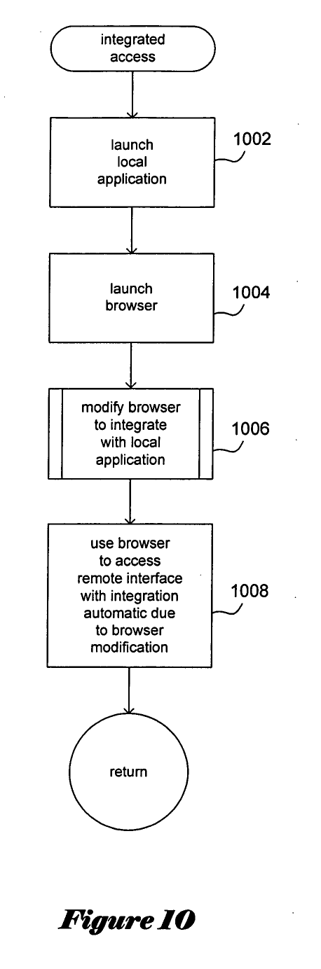

FIGS. 10-12show control-flow diagrams that represent a method embodiment of the present invention. FIG. 10 provides a control-flow diagram of an “integrated access” method that can be used to incorporate information generated by a first computational entity into a web page generated by a second computational entity to provide for a single, integrated display of information generated by both computational entities. In step 1002, a first application program, referred to as the “local application,” is launched to execute on a local computer. In step 1004, an Internet-browser application program is launched to execute on a local computer. In step 1006, the Internet-browser application is modified to integrate and synchronize the Internet-browser application with the local application launched in step 1002. Following modification of the Internet browser application in step 1006, the Internet-browser application can be directed, in step 1008, to access remotely stored, processed, and rendered information on a remote server, receiving from the remote server the HTML encoding of a web page. Upon receipt of the web page, the modified Internet-browser application automatically obtains corresponding information from the local application program, launched in step 1002, and incorporates the information generated by the local application into the received web page for integrated display to a user.

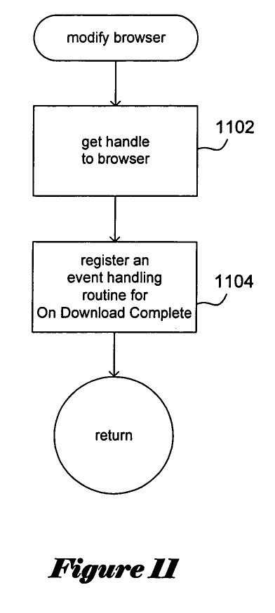

FIG. 11 illustrates the Internet-browser modification process invoked in step 1006of FIG. 10. In step 1102, a handle of the browser is programmatically obtained through an Internet-browser API. Next, in step 1104, an event-handling routine for the OnDownloadComplete event, in the case of an Internet Explorers Internet-browser application, is registered programmatically with the Internet-browser application, at runtime, through the Internet-browser application API.

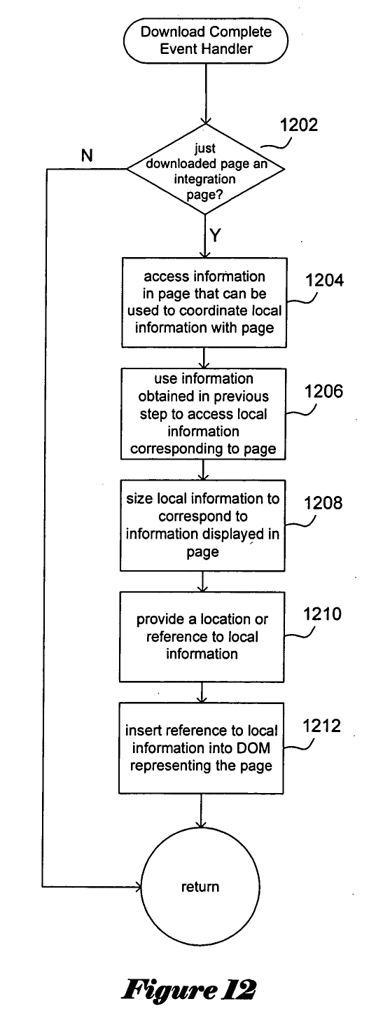

FIG. 12 provides a control-flow diagram for the event handler registered with the Internet-browser application in step 1104 in FIG. 11. In step 1202, the event handler determines whether the page just downloaded by the Internet-browser application, the downloading of the page having invoked the event handler, is a page with which local information generated by the local application program needs to be integrated or, in other words, whether the just-downloaded page is a target integration page. If not, the event handler returns. If the just-downloaded page is a target integration page then, in step 1204, information in the just-downloaded page is accessed to determine what locally generated information needs to be obtained from the local application to include in the target integration page, as well as to determine how to scale and align the locally generated information. Next, in step 1206, information obtained in step 1204is used to access the locally generated information from the local application program. In step 1208, the locally generated information accessed in step 1206is scaled and aligned with information included in the just-downloaded, target integration page. In step 1210, a reference or location is generated for the locally generated information obtained in step 1206and scaled and aligned in step 1208. Finally, in step 1212, the location or reference to the locally generated information is inserted into the DOM tree that represents the just-downloaded, target integration page that is obtained through a call to the Internet-browser API. Once the reference is inserted into the DOM tree, the event handler returns, allowing the Internet-browser application to then display the modified target integration page to the user. Modification of the DOM tree inserts the locally generated information into the web page for coordinated and simultaneous display with information included in the web page by a remote web site.

The method illustrated in FIGS. 10-12can be generalized to coordinate the current display of information generated by more than two computational entities, the computational entities residing on from one to multiple different computer systems. The described embodiment concerns a local application program that generates information as well as a remote web site, or server, that generates information, but the method of the present invention may also be used to integrate information generated by two or more local computational entities, two or more remote computational entities, or two or more computational entities distributed among various computer systems in various ways.

A relatively concise, Matlab prototype for integrating locally generated DNA-copy-number data with genomic data obtained from the UCSC genomic-data facility to produce the integrated display shown in FIG. 6 from the graphical visualizations shown in FIGS. 1 and 2is next provided:

| | |
|---|---|
| 1 | function I=MyGenomeViewerV2(g,chrPanelPeer) |
| 2 | if nargin<1 |

| | |
|---|---|
| 3 | g=gcf; |

| | |
|---|---|
| 4 | end |
| 5 | if nargin<2 |

| | |
|---|---|
| 6 | gp=getappdata(g,‘javaPeer’); |
| 7 | if isempty(gp) |

| | |
|---|---|
| 8 | return; |

| | |
|---|---|
| 9 | end |
| 10 | try |

| | |
|---|---|
| 11 | chrPanelPeer=gp.getVisChild( ).get(0); |

| | |
|---|---|
| 12 | catch |

| | |
|---|---|
| 13 | return; |

| | |
|---|---|
| 14 | end |

| | |
|---|---|
| 15 | end |
| 16 | ieAlive=false; |
| 17 | I=getappdata(0,‘IEHandle’); |
| 18 | if ˜isempty(I) && iscom(I) |

| | |
|---|---|
| 19 | try |

| | |
|---|---|
| 20 | I.application; |
| 21 | ieAlive=true; |

| | |
|---|---|
| 22 | catch |

| | |
|---|---|
| 23 | ieAlive=false; |

| | |
|---|---|
| 24 | end |

| | |
|---|---|
| 25 | end |
| 26 | if ˜ieAlive |

| | |
|---|---|
| 27 | try |

| | |
|---|---|
| 28 | I=actxserver(‘Internetexplorer.Application’); |
| 29 | |

registerevent(I,{‘DownloadComplete’,@OnDownloadComplete});

| | |
|---|---|
| 30 | addproperty(I,‘chrPanelPeer’); |
| 31 | addproperty(I,‘matlabFigH’); |
| 32 | addproperty(I,‘lastURL’); |
| 33 | addproperty(I,‘layoutColumnsWidth’); |
| 34 | I.lastURL=‘’; |
| 35 | addproperty(I,‘lastFramePos’); |
| 36 | setappdata(0,‘IEHandle’,I); |

| | |
|---|---|
| 37 | catch |

| | |
|---|---|
| 38 | errormsg(sprintf(‘%s error: could not start activeX |

server for

| | |
|---|---|
| 39 | InternetExplorer’,mfilename)); |

| | |
|---|---|
| 40 | I=[ ]; |
| 41 | return; |

| | |
|---|---|
| 42 | end |

| | |
|---|---|
| 43 | end |
| 44 | I.chrPanelPeer=chrPanelPeer; |
| 45 | I.matlabFigH=g; |
| 46 | chrPanel=chrPanelPeer.getMatlabPeer( ); |
| 47 | chr=ChrName(getappdata(chrPanel,‘chrId’)); |
| 48 | xd=get(chrPanelPeer.getZoomControlHandle,‘xData’); |
| 49 | |
| 50 | xl=xd(1:2); |
| 51 | bin/hgTracks?org=Human&db=hg16&position=chr%s:%d-%d&pix=%d′,... |
| 52 | guessedOffset=115; |
| 53 | |

I.layoutColumnsWidth=chrPanelPeer.getLayout( ).getLayoutDimensions{1}
;

| | |
|---|---|
| 54 | picWidth=I.layoutColumnsWidth(2)+guessedOffset; |
| 55 | url=sprintf(‘http://genome.ucsc.edu/cgi- |
| 56 | |

bin/hgTracks?clade=vertebrate&org=Human&db=hg17&position=chr%s:%d-

| | |
|---|---|
| 57 | %d&pix=%d’,... |

| | |
|---|---|
| 58 | chr,int32(xl(1)*1e6),int32(xl(2)*1e6),picWidth); |

| | |
|---|---|
| 59 | I.visible=1; |
| 60 | I.Navigate2(url); |
| 61 | function OnDownloadComplete(varargin) |
| 62 | ie=varargin{1}; |
| 63 | chrPanelPeer=ie.chrPanelPeer; |
| 64 | if ˜ishandle(chrPanelPeer) \|\| ˜isjava(chrPanelPeer) \|\| |
| 65 | ˜ishandle(chrPanelPeer.getMatlabPeer( )) |
| 66 | return; |
| 67 | end |
| 68 | if ˜strncmpi(ie.locationUrl,‘http://genome.ucsc.edu/cgi- |

bin/hgTracks’,39)

| | |
|---|---|
| 69 | return; |

| | |
|---|---|
| 70 | end |
| 71 | forms=ie.document.forms; |
| 72 | if ˜isempty(forms) && forms.length>0 |

| | |
|---|---|
| 73 | HeaderTrackForm=MyNamedItem(forms,‘TrackHeaderForm’); |

| | |
|---|---|
| 74 | else |

| | |
|---|---|
| 75 | return; |

| | |
|---|---|
| 76 | end |
| 77 | if isempty(HeaderTrackForm) |

| | |
|---|---|
| 78 | return; |

| | |
|---|---|
| 79 | end |
| 80 | Position=MyNamedItem(HeaderTrackForm.elements,‘position’); |
| 81 | if isempty(Position) \|\| length(Position)>1 |

| | |
|---|---|
| 82 | return; |

| | |
|---|---|
| 83 | else |

| | |
|---|---|
| 84 | PositionString=Position.value; |

| | |
|---|---|
| 85 | end |
| 86 | tokens=regexp(PositionString,‘\hat{ }chr([\hat{ }:]+):(\d+)− |

(\d+)’,‘tokens’);

| | |
|---|---|
| 87 | if isempty(tokens) |

| | |
|---|---|
| 88 | return; |

| | |
|---|---|
| 89 | end |
| 90 | cghImg=MyNamedItem(ie.document.all,‘cghTools’); |
| 91 | if ˜isempty(cghImg) |

| | |
|---|---|
| 92 | return; |

| | |
|---|---|
| 93 | end |
| 94 | ieChr=tokens{:}{1}; |
| 95 | minX=str2num(tokens{:}{2})/1e6; |
| 96 | maxX=str2num(tokens{:}{3})/1e6; |
| 97 | chrPanelPeer=ie.chrPanelPeer; |
| 98 | chrPanel=chrPanelPeer.getMatlabPeer( ); |
| 99 | zoomControl=chrPanelPeer.getZoomControlHandle; |
| 100 | xd=get(zoomControl,‘xData’); |
| 101 | xl=xd(1:2)’; |
| 102 | if ˜all([minX maxX]==xl) |

| | |
|---|---|
| 103 | xl=[minX maxX]; |
| 104 | set(zoomControl,‘xdata’,xl([1 2 2 1 1])); |
| 105 | axList=chrPanelPeer.getMatlabPlotAxes( ); |
| 106 | set(axList,‘Xlim’,xl); |

| | |
|---|---|
| 107 | end |
| 108 | fig=ie.matlabFigH; |
| 109 | pos=get(chrPanel,‘pos’); |
| 110 | idth(1)−115; |
| 111 | |

[offset,width]=findUCSCgifOffset(ie.document.images.item(1).href);

| | |
|---|---|
| 112 | leftDelta=double(offset-ie.layoutColumnsWidth(1)- |
| 113 | chrPanelPeer.getInsets.left); |
| 114 | winHeight=pos(4); |
| 115 | ie.visible=0; |
| 116 | mX=frame2im(getframe(fig,pos)); |
| 117 | [r,c,p]=size(mX); |
| 118 | mX=[repmat(255,[r,leftDelta,p]) mX]; |
| 119 | ie.visible=1; |
| 120 | imwrite(mX,fullfile(pwd,‘temp.png’)); |
| 121 | ie.lastFramePos=PositionString; |
| 122 | D=ie.Document; |
| 123 | B=D.Body; |
| 124 | if ˜isempty(cghImg) |

| | |
|---|---|
| 125 | nImg=cghImg.length; |
| 126 | if nImg==1%only a single img |

| | |
|---|---|
| 127 | cghImg.previousSibling.removeNode(false); |
| 128 | cghImg.removeNode(false); |

| | |
|---|---|
| 129 | else |

| | |
|---|---|
| 130 | for i=0:nImg−1 |

| | |
|---|---|
| 131 | cghImg.item(i).previousSibling.removeNode(‘false’); |
| 132 | cghImg.item(i).previousSibling.removeNode(‘false’) |

| | |
|---|---|
| 133 | end |

| | |
|---|---|
| 134 | end |

| | |
|---|---|
| 135 | else |
| 136 | end |
| 137 | img=ie.document.images.item(1); |
| 138 | delta=ie.layoutColumnsWidth(3)+chrPanelPeer.getInsets.right; |
| 139 | extendUCSCImg(img,delta); |
| 140 | img.src=fullfile(pwd,‘localUCSCAnnot.gif’); |
| 141 | img.width=img.width+delta; |
| 142 | img2=img.cloneNode(false); |
| 143 | img2.src=fullfile(pwd,‘temp.png’); |
| 144 | img2.height=winHeight; |
| 145 | img2.name=‘cghTools’; |
| 146 | br=img.nextSibling; |
| 147 | br2=br.cloneNode(false); |
| 148 | parent=img.parentnode; |
| 149 | parent.insertBefore(img2,img); |
| 150 | parent.insertBefore(br2,img); |
| 151 | function extendUCSCImg(img,delta) |
| 152 | [X,map]=imread(img.src); |
| 153 | X(:,end+1:end+delta)=uint8(0); |
| 154 | imwrite(X,map,fullfile(pwd,‘localUCSCAnnot.gif’)); |

Portions of the code corresponding to steps in the control-flow diagrams shown in FIGS. 10-12 are next provided. A handle to the Internet-browser application is obtained, as in step 1102 of FIG. 11, on lines 1-25 of the Matlab code, which may involve launching the Internet-browser application, as in step 1004 of FIG. 10, on line 20 of the Matlab code. The event handler is registered with the Internet-application browser, as in step 1104 of FIG. 11, on line 29 of the Matlab code. The event handler diagrammed in FIG. 12 is found on lines 61-150 of the Matlab code. The conditional step 1202 is encoded on lines 68-70 of the Matlab code. Step 1204 of the event handler, in which information is accessed to specify the locally generated information, is found on lines 71-89 of the Matlab code. This code employs the Internet browser API to obtain a list of the form entities within the DOM tree representing the web page on line 71 of the Matlab code. Then, the form that includes the position/search input field is accessed, and the current chromosomal position is obtained from the DOM tree. This information allows the Matlab code, beginning on line 99, to obtain, scale, and align a graphical visualization of the portion of the chromosome to which the web page is directed to be obtained and scaled from the local application, as in steps 1206 and 1208. The locally generated graphical visualization is written to a local .png file on line 120 of the Matlab code, thus providing a location for the locally generated graphical visualization, as in step 1210 of FIG. 12. Finally, beginning on line 122 of the Matlab code, the DOM tree representing the web page is traversed to find the [IMG] portion, or subtree, representing the first image (710 in FIG. 7A) in the web page, so that the locally generated graphical visualization can be inserted following that image on line 149 of the Matlab code, as in step 1212 of FIG. 12. Once the locally generated graphical visualization is inserted into the DOM tree, the event handler returns, and the Internet-browser application then renders the modified DOM tree for display to a user, and transmits the rendered web page to the local display device.

Although the present invention has been described in terms of particular embodiments, it is not intended that the invention be limited to these embodiments. Modifications within the spirit of the invention will be apparent to those skilled in the art. For example, the method of the present invention can be encoded in one or more routines written in any number of different programming languages using an almost limitless number of different modularizations, control structures, data structures, and other such programming variations. As discussed above, methods of the present invention can be employed to integrate information, images, audio signals, or other such digitally encoded information generated by any number of different computational entities together into a single-user interface, without the problems discussed with reference to FIGS. 5A-B. Methods of the present invention can be encoded into a routine that runs in a local computer, as in the discussed-above example, in order to produce a locally executed routine that invokes both a local application program and an Internet-browser application to provide graphical visualizations that are combined into a single web page, as in the above-discussed example. However, a wide variety of different system embodiments of the present invention may include additional routines, programs, and other computational entities that are coordinated with the methods of the present invention in order to produce integrated presentation of discrete pieces of information through a single, integrated interface.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for integrating display information provided by two or more computational entities, the method comprising:
modifying a first computational entity that renders electronically-encoded display information, received from a second computational entity to display a first user interface, to invoke an external event handler upon receiving the electronically-encoded display information; and
when receiving of the electronically-encoded display information invokes the external event handler,
accessing information in the electronically-encoded display information to determine additional electronically-encoded display information to obtain from a third computational entity,
obtaining the additional electronically-encoded display information from the third computational entity, and
modifying, by the external event handler, the received electronically-encoded display information in order to incorporate the additional electronically-encoded display information into the user interface for display by the first computational entity.

2. The method of claim 1 wherein the first computational entity is an Internet-browser application program and wherein the electronically-encoded display information encodes one or more web pages.

3. The method of claim 2 wherein the external event handler is associated with an electronically-encoded-display-information-reception event generated by the Internet-browser application program.

4. The method of claim 3 wherein the electronically-encoded-display-information-reception event is an OnDownloadComplete event.

5. The method of claim 2 wherein the electronically-encoded display information includes an HTML description of at least a portion of the one or more web pages.

6. The method of claim 1 wherein the second computational entity is one of:
a web server;
a data server; and
a data-storage-facility interface.

7. The method of claim 1 wherein the third computational entity is one of:
a database management system;
an application program; and
a data-storage-facility interface.

8. The method of claim 1 wherein modifying the received electronically-encoded display information in order to incorporate the additional electronically-encoded display information into the user interface for display by the first computational entity further includes:
accessing information in the electronically-encoded display information to determine rendering parameters for the additional electronically-encoded display information;
rendering the additional electronically-encoded display information according to the rendering parameters;
identifying a position within the received electronically-encoded display information to insert additional electronically-encoded display information; and
inserting the rendered additional electronically-encoded display information into the received electronically-encoded display information.

9. The method of claim 8 wherein rendering parameters include parameters that specify scaling of the additional electronically-encoded display information to coordinate display of the additional electronically-encoded display information with the received electronically-encoded display information.

10. The method of claim 8 wherein rendering parameters include parameters that specify alignment of the additional electronically-encoded display information to coordinate display of the additional electronically-encoded display information with the received electronically-encoded display information.

11. The method of claim 8 wherein the received electronically-encoded display information is represented as a hierarchy, and inserting the rendered additional electronically-encoded display information into the received electronically-encoded display information further comprises inserting the rendered additional electronically-encoded display information into the hierarchy at a desirable level and connected with a desired parent entity within the hierarchy.

12. The method of claim 11 wherein the hierarchy is a document object model tree based on an HTML description of at least a portion of the received electronically-encoded display information.

13. The method of claim 1 further including:
repeatedly
receiving input through the user input produced by rendering electronically-encoded display information received from the second computational entity;
transmitting the received input to the second computational entity; and
receiving electronically-encoded display information from the second computational entity modified according to the transmitted received input that specifies an updated user interface, invoking the external event handler to accordingly receive updated additional electronically-encoded display information from the third computational entity in order to incorporate the updated additional electronically-encoded display information into the updated user interface for display by the first computational entity.

14. A system for integrating display information provided by two or more computational entities, the system comprising:
a first computational entity that renders electronically-encoded display information to display a user interface, the first computational entity modified to invoke an external event handler upon receiving target electronically-encoded display information;
a second computational entity that provides the target electronically-encoded display information;
a third computational entity that provides additional electronically-encoded display information; and
the external event handler that, when invoked by receiving of the electronically-encoded display information,
accesses information in the electronically-encoded display information to determine which additional electronically-encoded display information to obtain from the third computational entity,
obtains the determined additional electronically-encoded display information from the third computational entity, and
modifies the received electronically-encoded display information in order to incorporate the determined additional electronically-encoded display information into the user interface for display by the first computational entity.

15. The system of claim 14 wherein the first computational entity is an Internet-browser application program and wherein the electronically-encoded display information encodes one or more web pages.

16. The system of claim 15 wherein the external event handler is associated with an electronically-encoded-display-information-reception event generated by the Internet-browser application program.

17. The system of claim 15 wherein the electronically-encoded display information includes an HTML description of at least a portion of the one or more web pages.

18. The system of claim 14 wherein the second computational entity is one of:
a web server;
a data server; and
a data-storage-facility interface.

19. The system of claim 14 wherein the third computational entity is one of:
a database management system;
an application program; and
a data-storage-facility interface.

20. The system of claim 14 wherein the external event handler modifies the received electronically-encoded display information in order to incorporate the additional electronically-encoded display information into the user interface for display by the first computational entity by:
accessing information in the electronically-encoded display information to determine rendering parameters for the additional electronically-encoded display information;
rendering the additional electronically-encoded display information according to the rendering parameters;
identifying a position within the received electronically-encoded display information to insert a handle for the rendered additional electronically-encoded display information; and
inserting the rendered additional electronically-encoded display information into the received electronically-encoded display information.

21. The system of claim 20 wherein rendering parameters include parameters that specify scaling of the additional electronically-encoded display information to coordinate display of the additional electronically-encoded display information with the received electronically-encoded display information.

22. The system of claim 20 wherein rendering parameters include parameters that specify alignment of the additional electronically-encoded display information to coordinate display of the additional electronically-encoded display information with the received electronically-encoded display information.

23. The system of claim 20 wherein the received electronically-encoded display information is represented as a hierarchy, and inserting the rendered additional electronically-encoded display information into the received electronically-encoded display information further comprises inserting the rendered additional electronically-encoded display information into the hierarchy at a desirable level and connected with a desired parent entity within the hierarchy.

24. The system of claim 23 wherein the hierarchy is a document object model tree based on an HTML description of at least a portion of the received electronically-encoded display information.

25. The system of claim 14
wherein the system repeatedly
receives input through the user input produced by rendering electronically-encoded display information received from the second computational entity;
transmits the received input to the second computational entity; and
receives electronically-encoded display information from the second computational entity modified according to the transmitted received input that specifies an updated user interface, invoking the external event handler to accordingly receive updated additional electronically-encoded display information from the third computational entity in order to incorporate the updated additional electronically-encoded display information into the updated user interface for display by the first computational entity.
